(19) United States
(12) Patent Application Publication
(10) Pub. No.: US 2011/0188771 A1
(43) Pub. Date: Aug. 4, 2011

(54) IMAGE PROCESSING DEVICE, IMAGE PROCESSING METHOD, AND PROGRAM

(75) Inventor: Jun YOKONO, Tokyo (JP)

(73) Assignee: Sony Corporation, Tokyo (JP)

(21) Appl. No.: 12/965,104

(22) Filed: Dec. 10, 2010

(30) Foreign Application Priority Data
Feb. 3, 2010 (JP) 2010-022371

(51) Int. Cl. G06K 9/40

(52) U.S. Cl. 382/260

(57) ABSTRACT

An image processing device that recognizes an object present in an image includes a filter calculation unit configured to obtain a plurality of filter outputs by applying a plurality of directional selectivity filters, which respectively correspond to different directions, to the image, and a feature amount calculation unit configured to calculate a plurality of feature amounts with respect to the image based on the filter outputs, which respectively correspond to adjacent angles, of the plurality of directional selectivity filters.

### BACKGROUND OF THE INVENTION

1. Field of the Invention

The present invention relates to an image processing device, an image processing method, and a program. In particular, the present invention relates to an image processing device, an image processing method, and a program which are preferable to be used in recognizing an object present in an image.

2. Description of the Related Art

In related art, such a method has been commonly used that a directional selectivity filter is applied to an image (referred to below as a processing target image) so as to extract a feature amount of the processing target image and an object on the processing target image is recognized based on the extracted feature amount (for example, refer to Robust Real-Time Object Detection, by Paul Viola & Michael Jones, International Journal of Computer Vision 2001).

### SUMMARY OF THE INVENTION

In the method in Robust Real-Time Object Detection, by Paul Viola & Michael Jones, International Journal of Computer Vision 2001, an output value of the directional selectivity filter which is applied to the processing target image is directly used as a feature amount of the processing target image. Accordingly, when the object rotates or deforms on the processing target image, the output value of the directional selectivity filter varies in accordance with the rotation or the deformation. Thus, it has been difficult to recognize the object in high accuracy.

It is desirable to maintain invariance of a feature amount and recognize an object from a processing target image in high accuracy even when the object on the processing target image rotates.

An image processing device, according to an embodiment of the present invention, that recognizes an object present in an image includes a filter calculation means for obtaining a plurality of filter outputs by applying a plurality of directional selectivity filters, which respectively correspond to different directions, to the image, and a feature amount calculation means for calculating a plurality of feature amounts with respect to the image based on the filter outputs, which respectively correspond to adjacent angles, of the plurality of directional selectivity filters.

The feature amount calculation means may add the filter outputs, which respectively correspond to adjacent angles, of two of the directional selectivity filters to each other so as to calculate the plurality of feature amounts with respect to the image.

The feature amount calculation means may square the filter outputs, which respectively correspond to adjacent angles, of two of the directional selectivity filters and add the squared outputs to each other so as to calculate the plurality of feature amounts with respect to the image.

The feature amount calculation means may select a larger value of the filter outputs, which respectively correspond to adjacent angles, of two of the directional selectivity filters so as to calculate the plurality of feature amounts with respect to the image.

The feature amount calculation means may calculate a difference absolute value of the filter outputs, which respectively correspond to adjacent angles, of two of the directional selectivity filters so as to calculate the plurality of feature amounts with respect to the image.

The image processing device according to the embodiment of the present invention may further include a recognition means for recognizing the object present in the image based on the plurality of feature amounts, which are calculated, with respect to the image.

The directional selectivity filters may be one of rectangle filters, steerable filters, and Gabor filters.

An image processing method according to another embodiment of the present invention incorporated in an image processing device that recognizes an object present in an image includes the steps of applying a plurality of directional selectivity filters, which respectively correspond to different directions, to the image so as to obtain a plurality of filter outputs, and calculating a plurality of feature amounts with respect to the image based on the filter outputs, which respectively correspond to adjacent angles, of the plurality of directional selectivity filters.

A program according to still another embodiment of the present invention used for controlling an image processing device that recognizes an object present in an image lets a computer of the image processing device execute a process including the steps of applying a plurality of directional selectivity filters, which respectively correspond to different directions, to the image so as to obtain a plurality of filter outputs, and calculating a plurality of feature amounts with respect to the image based on the filter outputs, which respectively correspond to adjacent angles, of the plurality of directional selectivity filters.

According to the embodiments of the present invention, the plurality of directional selectivity filters that respectively correspond to different directions are applied to the image so as to obtain the plurality of filter outputs, and the plurality of feature amounts with respect to the image are calculated based on the filter outputs, which respectively correspond to adjacent angles, of the plurality of directional selectivity filters.

According to the embodiments of the present invention, even when the object on the processing target image rotates, invariance of the feature amounts can be maintained.

Further, according to the embodiments of the present invention, the object on the processing target image can be recognized in high accuracy.

### BRIEF DESCRIPTION OF THE DRAWINGS

FIG. 1 is a block diagram showing a configuration example of an object recognition device to which an embodiment of the present invention is applied;

FIG. 2 is a block diagram showing a first configuration example of a feature amount extraction unit of FIG. 1;

FIGS. 3A to 3D illustrate an example of a rectangle filter;

FIGS. 4A to 4D illustrate an example of a steerable filter;

FIG. 5 illustrates an example of an output of the rectangle filter;

FIG. 6 is a flowchart for explaining object recognition processing;

FIG. 7 is a block diagram showing a second configuration example of the feature amount extraction unit of FIG. 1;

FIG. 8 is a block diagram showing a third configuration example of the feature amount extraction unit of FIG. 1;

FIG. 9 is a block diagram showing a fourth configuration example of the feature amount extraction unit of FIG. 1; and

FIG. 10 is a block diagram showing a configuration example of a computer.

### DESCRIPTION OF THE PREFERRED EMBODIMENTS

A preferred embodiment of the present invention (referred to below as an embodiment) will be described in detail with reference to the accompanying drawings.

### 1. Embodiment

### [Configuration Example of Object Recognition Device]

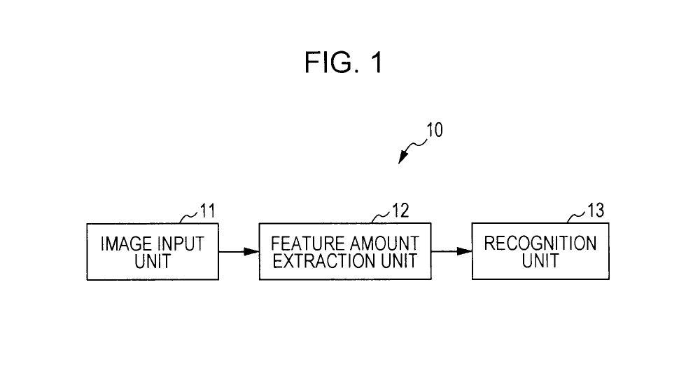

FIG. 1 illustrates a configuration example of an object recognition device which is an embodiment of the present invention. This object recognition device 10 includes an image input unit 11, a feature amount extraction unit 12, and a recognition unit 13.

The image input unit 11 inputs a processing target image into the feature amount extraction unit 12 on a subsequent stage. The feature amount extraction unit 12 applies directional selectivity filters which respectively correspond to a plurality of different directions to the processing target image and performs a predetermined calculation with respect to output values of the respective directional selectivity filters so as to calculate first to fourth feature amounts of the processing target image. The recognition unit 13 refers the first to fourth feature amounts, which are calculated, to a predetermined database in which the first to fourth feature amounts are associated with various objects, so as to recognize an object on the processing target image.

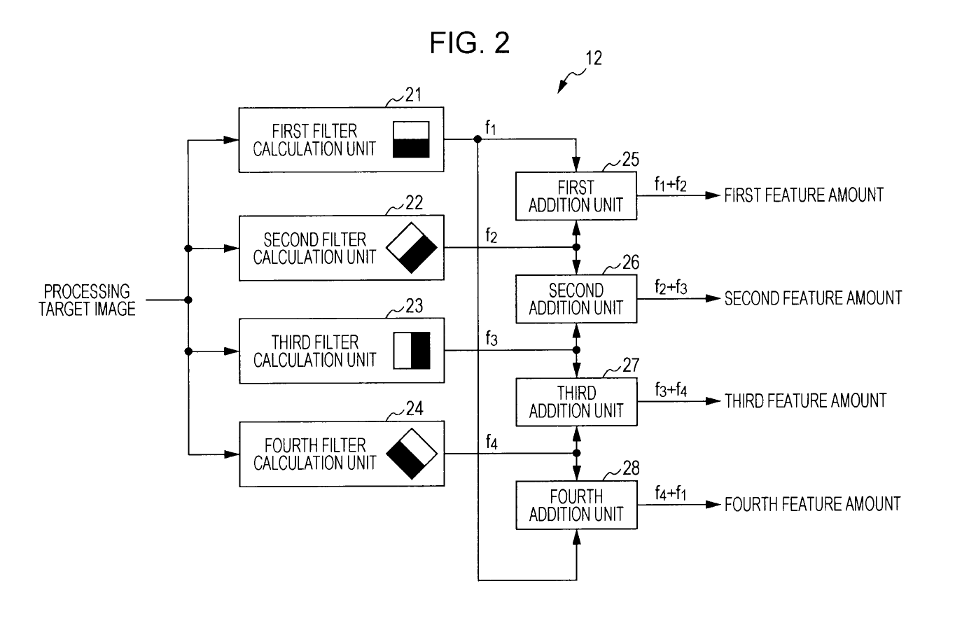

FIG. 2 illustrates a first configuration example of the feature amount extraction unit 12. The first configuration example includes a first filter calculation unit 21, a second filter calculation unit 22, a third filter calculation unit 23, a fourth filter calculation unit 24, a first addition unit 25, a second addition unit 26, a third addition unit 27, and a fourth addition unit 28.

The first filter calculation unit 21 includes a directional selectivity filter of a 0-degree direction (a horizontal direction on a screen). The first filter calculation unit 21 applies the directional selectivity filter of the 0-degree direction with respect to the processing target image which is inputted from the previous stage, and outputs a resulting output value f₁ to the fourth addition unit 28 and the first addition unit 25.

The second filter calculation unit 22 includes a directional selectivity filter of a 45-degree direction (a lower left and upper right direction on the screen). The second filter calculation unit 22 applies the directional selectivity filter of the 45-degree direction with respect to the processing target image which is inputted from the previous stage, and outputs a resulting output value f₂ to the first addition unit 25 and the second addition unit 26.

The third filter calculation unit 23 includes a directional selectivity filter of a 90-degree direction (a vertical direction on the screen). The third filter calculation unit 23 applies the directional selectivity filter of the 90-degree direction with respect to the processing target image which is inputted from the previous stage, and outputs a resulting output value f₃ to the second addition unit 26 and the third addition unit 27.

The fourth filter calculation unit 24 includes a directional selectivity filter of a 135-degree direction (an upper left and lower right direction on the screen). The fourth filter calculation unit 24 applies the directional selectivity filter of the 135-degree direction with respect to the processing target image which is inputted from the previous stage, and outputs a resulting output value f₄ to the third addition unit 27 and the fourth addition unit 28.

Here, the drawing shows rectangle filters as the directional selectivity filters which are respectively included in the first filter calculation unit 21 to the fourth filter calculation unit 24, but these filters are merely an example and the directional selectivity filters are not limited to the rectangle filters.

The first addition unit 25 adds the output value f₁ of the first filter calculation unit 21 to the output value f₂ of the second filter calculation unit 22 and outputs resulting f₁+f₂ to the recognition unit 13 as a first feature amount.

The second addition unit 26 adds the output value f₂ of the second filter calculation unit 22 to the output value f₃ of the third filter calculation unit 23 and outputs resulting f₂+f₃ to the recognition unit 13 as a second feature amount.

The third addition unit 27 adds the output value f₃ of the third filter calculation unit 23 to the output value f₄ of the fourth filter calculation unit 24 and outputs resulting f₃+f₄ to the recognition unit 13 as a third feature amount.

The fourth addition unit 28 adds the output value f₄ of the fourth filter calculation unit 24 to the output value f₁ of the first filter calculation unit 21 and outputs resulting f₄+f₁ to the recognition unit 13 as a fourth feature amount.

### [Example of Directional Selectivity Filter]

Examples of the directional selectivity filters of four directions which are respectively included in the first filter calculation unit 21 to the fourth filter calculation unit 24.

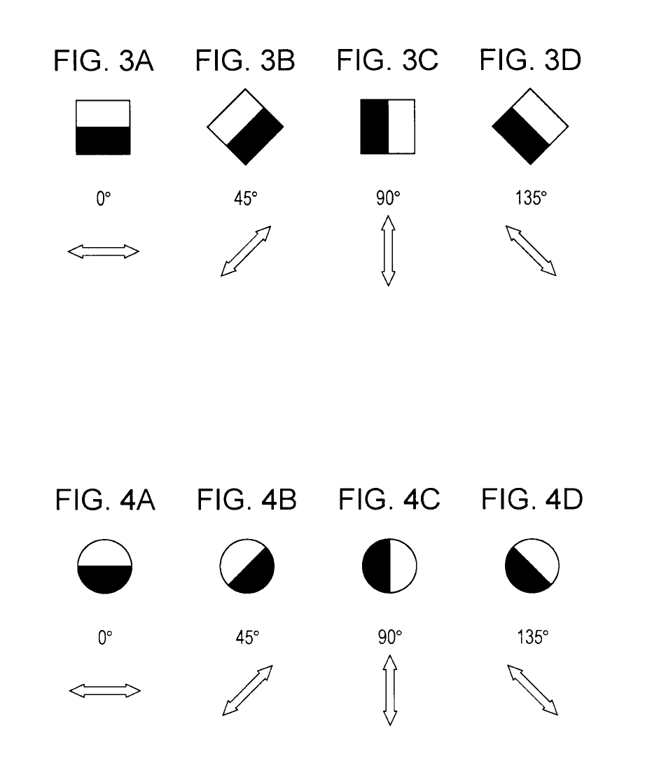

FIGS. 3A to 3D illustrate an example of a rectangle filter which is applicable as a directional selectivity filter. FIG. 3A illustrates a rectangle filter of a 0-degree direction, FIG. 3B illustrates a rectangle filter of a 45-degree direction, FIG. 3C illustrates a rectangle filter of a 90-degree direction, and FIG. 3D illustrates a rectangle filter of a 135-degree direction.

FIGS. 4A to 4D illustrate an example of a steerable filter which is applicable as a directional selectivity filter. FIG. 4A illustrates a steerable filter of a 0-degree direction, FIG. 4B illustrates a steerable filter of a 45-degree direction, FIG. 4C illustrates a steerable filter of a 90-degree direction, and FIG. 4D illustrates a steerable filter of a 135-degree direction.

The first filter calculation unit 21 to the fourth filter calculation unit 24 can adopt a directional filter such as a Gabor filter as well as the rectangle filter and the steerable filter which are described above. Further, the number and the direction of the directional selectivity filters are not limited to the number and the direction of the example described above.

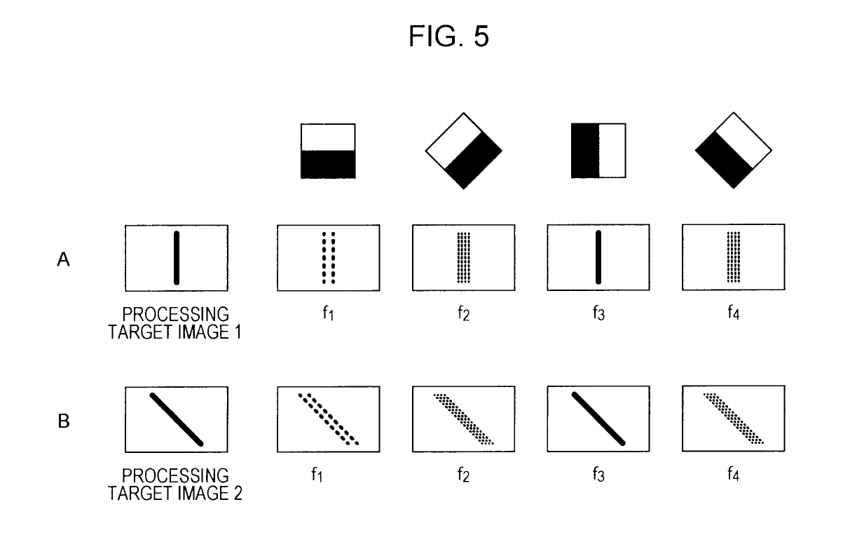

FIG. 5 schematically illustrates images after filtering which are obtained by applying directional selectivity filters (rectangle filters in a case of FIG. 5) of four directions with respect to a processing target image. It is the output values f₁ to f₄ of the first filter calculation unit 21 to the fourth filter calculation unit 24 that the images after filtering are expressed as numerical values.

As shown in part A in FIG. 5, when an object extending in a vertical direction is present in a processing target image, an output value from the third filter calculation unit 23 including the directional selectivity filter of the 90-degree direction is largest, and thus output values from the first filter calculation unit 21, the second filter calculation unit 22, and the fourth filter calculation unit 24 including the directional selectivity filters of other directions are smaller than the output value from the third filter calculation unit 23.

Further, as shown in part B in FIG. 5, when an object extending in an upper left and lower right direction is present in the processing target image, an output value from the fourth filter calculation unit 24 including the directional selectivity filter of the 135-degree direction is largest, and thus output values of the first filter calculation unit 21, the second filter calculation unit 22, and the third filter calculation unit 23 including the directional selectivity filters of other directions are smaller than the output value from the fourth filter calculation unit 24.

That is, it is understood that among the output values f₁ to f₄ of the first filter calculation unit 21 to the fourth filter calculation unit 24, only the output value corresponding to the directional selectivity filter of the same direction as that of an object on the processing target image is large. In a case where the output values f₁ to f₄ are directly employed as the feature amounts, the feature amounts vary only when an identical object rotates by a degree from about 0 degree to 45 degrees. Thus, it is difficult to obtain a correct recognition result.

However, in the embodiment, the feature amounts do not vary even when the identical object rotates by a degree from about 0 degree to 45 degrees on a processing target image.

Specifically, as described above, f₁+f₂ obtained by adding the output value f₁ to the output value f₂, f₂+f₃ obtained by adding the output value f₂ to the output value f₃, f₃+f₄ obtained by adding the output value f₃ to the output value f₄, and f₄+f₁ obtained by adding the output value f₄ to the output value f₁ are respectively used as the first feature amount, the second feature amount, the third feature amount, and the fourth feature amount.

Accordingly, even when the identical object rotates by a degree from about 0 degree to 45 degrees on the processing target image, the recognition unit 13 on the subsequent stage can recognize the object in high accuracy because the first to fourth feature amounts are invariant.

### [Explanation of Operation]

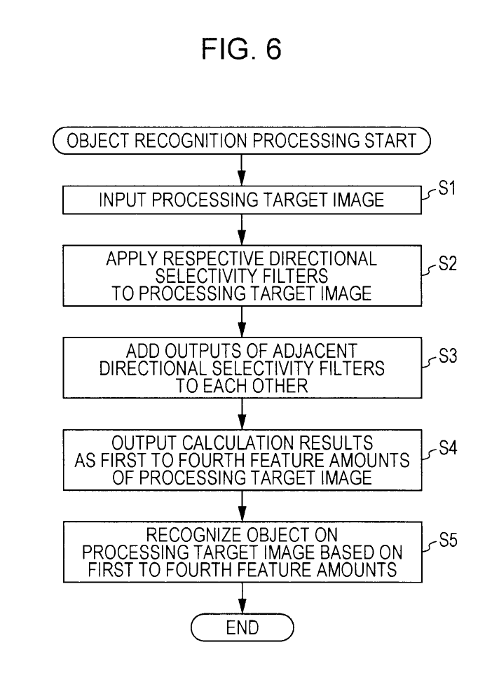

FIG. 6 is a flowchart for explaining object recognition processing in a case where the feature amount extraction unit 12 adopts the first configuration example.

In step S1, the image input unit 11 inputs a processing target image into the feature amount extraction unit 12 on the subsequent stage. The feature amount extraction unit 12 distributes the inputted processing target image to the first filter calculation unit 21 to the fourth filter calculation unit 24.

In step S2, the first filter calculation unit 21 applies the directional selectivity filter of the 0-degree direction included therein with respect to the inputted processing target image and outputs the resulting output value f₁ to the fourth addition unit 28 and the first addition unit 25. In a similar manner, the second filter calculation unit 22 outputs the output value f₂ to the first addition unit 25 and the second addition unit 26. The third filter calculation unit 23 outputs the output value f₃ to the second addition unit 26 and the third addition unit 27. The fourth filter calculation unit 24 outputs the output value f₄ to the third addition unit 27 and the fourth addition unit 28.

In step S3, the first addition unit 25 adds the output value f₁ to the output value f₂. In a similar manner, the second addition unit 26 adds the output value f₂ to the output value f₃. The third addition unit 27 adds the output value f₃ to the output value f₄. The fourth addition unit 28 adds the output value f₄ to the output value f₁.

In step S4, the first addition unit 25 to the fourth addition unit 28 output added values which are respective calculation results to the recognition unit 13 on the subsequent stage, as the first to fourth feature amounts.

In step S5, the recognition unit 13 refers the first to fourth feature amounts, which are calculated, to the predetermined database in which the first to fourth feature amounts are associated with various objects, so as to recognize an object on the processing target image. The explanation of the object recognition processing is ended here.

### [Modification]

Other configuration examples of the feature amount extraction unit 12 will be next described.

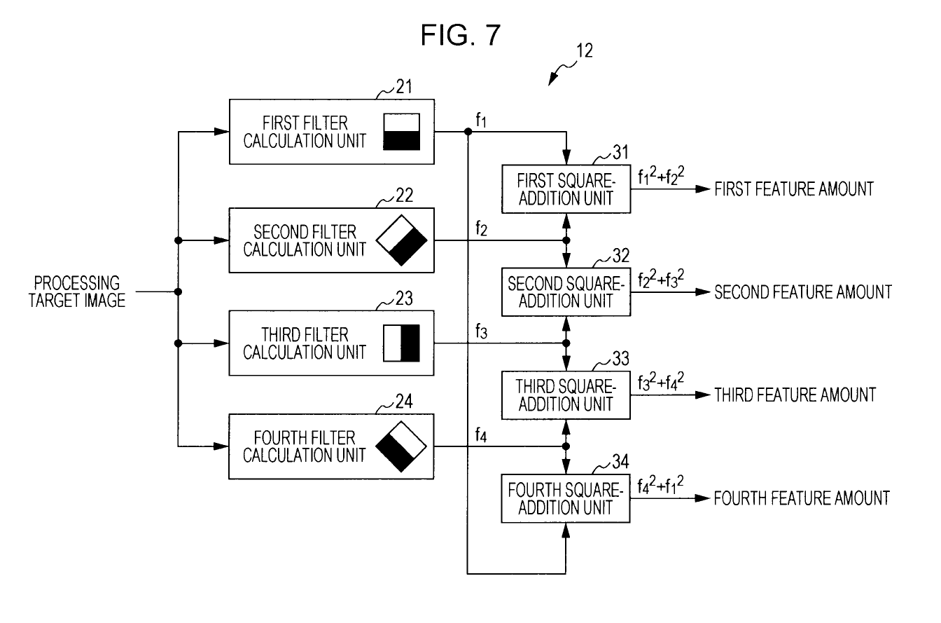

FIG. 7 illustrates a second configuration example of the feature amount extraction unit 12. In the second configuration example, a first square-addition unit 31 to a fourth square-addition unit 34 are provided instead of the first addition unit 25 to the fourth addition unit 28 in the first configuration example shown in FIG. 2, and the first filter calculation unit 21 to the fourth filter calculation unit 24 are commonly provided.

The first square-addition unit 31 squares the output value f₁ of the first filter calculation unit 21 and the output value f₂ of the second filter calculation unit 22 respectively and adds the resulting values to each other so as to output resulting f₁²+f₂² to the recognition unit 13 as a first feature amount.

The second square-addition unit 32 squares the output value f₂ of the second filter calculation unit 22 and the output value f₃ of the third filter calculation unit 23 respectively and adds the resulting values to each other so as to output resulting f₂²+f₃² to the recognition unit 13 as a second feature amount.

The third square-addition unit 33 squares the output value f₃ of the third filter calculation unit 23 and the output value f₄ of the fourth filter calculation unit 24 respectively and adds the resulting values to each other so as to output resulting f₃²+f₄² to the recognition unit 13 as a third feature amount.

The fourth square-addition unit 34 squares the output value f₄ of the fourth filter calculation unit 24 and the output value f₁ of the first filter calculation unit 21 respectively and adds the resulting values to each other so as to output resulting f₄²+f₁² to the recognition unit 13 as a fourth feature amount.

Object recognition processing in the case where the feature amount extraction unit 12 adopts the second configuration example is same as the object recognition processing in the case where the feature amount extraction unit 12 adopts the first configuration example described above, so that the description thereof will be omitted.

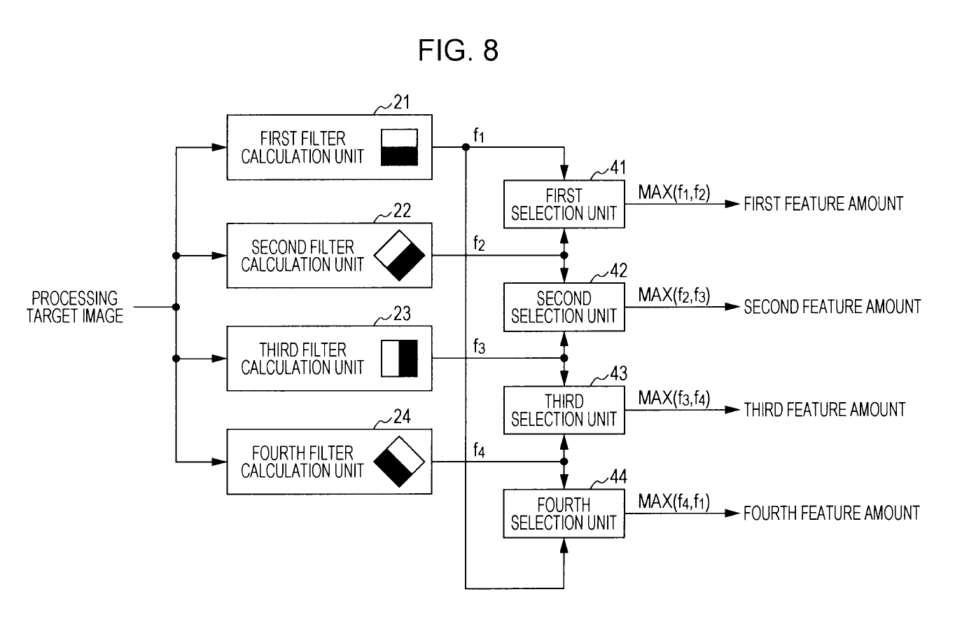

FIG. 8 illustrates a third configuration example of the feature amount extraction unit 12. In the third configuration example, a first selection unit 41 to a fourth selection unit 44 are provided instead of the first addition unit 25 to the fourth addition unit 28 in the first configuration example shown in FIG. 2, and the first filter calculation unit 21 to the fourth filter calculation unit 24 are commonly provided.

The first selection unit 41 selects a larger value from the output value f₁ of the first filter calculation unit 21 and the output value f₂ of the second filter calculation unit 22 and outputs the selected value to the recognition unit 13 as a first feature amount.

The second selection unit 42 selects a larger value from the output value f₂ of the second filter calculation unit 22 and the output value f₃ of the third filter calculation unit 23 and outputs the selected value to the recognition unit 13 as a second feature amount.

The third selection unit 43 selects a larger value from the output value f₃ of the third filter calculation unit 23 and the output value f₄ of the fourth filter calculation unit 24 and outputs the selected value to the recognition unit 13 as a third feature amount.

The fourth selection unit 44 selects a larger value from the output value f₄ of the fourth filter calculation unit 24 and the output value f₁ of the first filter calculation unit 21 and outputs the selected value to the recognition unit 13 as a fourth feature amount.

Object recognition processing in the case where the feature amount extraction unit 12 adopts the third configuration example is same as the object recognition processing in the case where the feature amount extraction unit 12 adopts the first configuration example described above, so that the description thereof will be omitted.

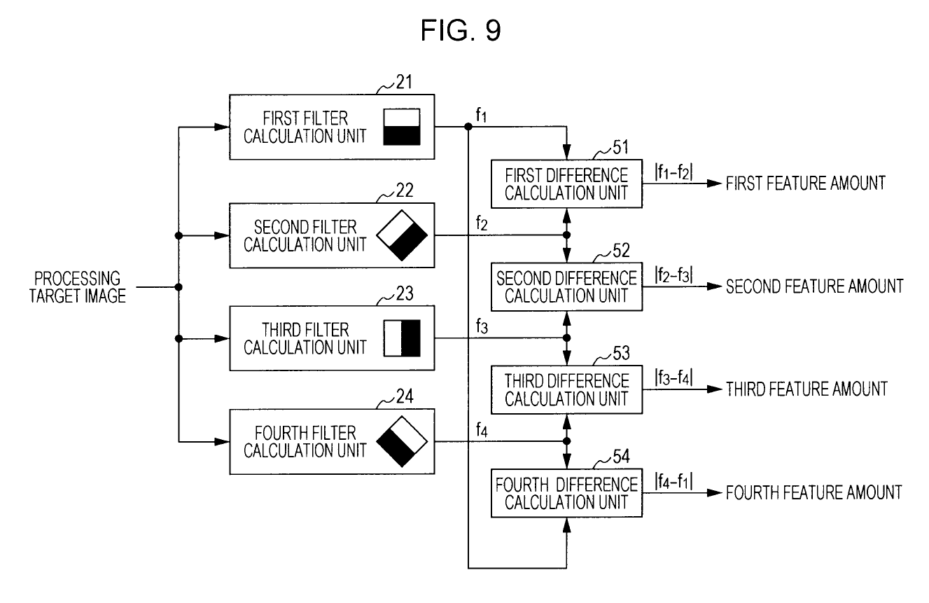

FIG. 9 illustrates a fourth configuration example of the feature amount extraction unit 12. In the fourth configuration example, a first difference calculation unit 51 to a fourth difference calculation unit 54 are provided instead of the first addition unit 25 to the fourth addition unit 28 in the first configuration example shown in FIG. 2, and the first filter calculation unit 21 to the fourth filter calculation unit 24 are commonly provided.

The first difference calculation unit 51 calculates a difference absolute value between the output value f₁ of the first filter calculation unit 21 and the output value f₂ of the second filter calculation unit 22 and outputs resulting |f₁-f₂| to the recognition unit 13 as a first feature amount.

The second difference calculation unit 52 calculates a difference absolute value between the output value f₂ of the second filter calculation unit 22 and the output value f₃ of the third filter calculation unit 23 and outputs resulting |f₂-f₃| to the recognition unit 13 as a second feature amount.

The third difference calculation unit 53 calculates a difference absolute value between the output value f₃ of the third filter calculation unit 23 and the output value f₄ of the fourth filter calculation unit 24 and outputs resulting |f₃-f₄| to the recognition unit 13 as a third feature amount.

The fourth difference calculation unit 54 calculates a difference absolute value between the output value f₄ of the fourth filter calculation unit 24 and the output value f₁ of the first filter calculation unit 21 and outputs resulting |f₄-f₁| to the recognition unit 13 as a fourth feature amount.

Object recognition processing in the case where the feature amount extraction unit 12 adopts the fourth configuration example is same as the object recognition processing in the case where the feature amount extraction unit 12 adopts the first configuration example described above, so that the description thereof will be omitted.

In cases where the feature amount extraction unit 12 adopts the second to fourth configuration examples as well, even when an identical object rotates by a degree from about 0 degree to 45 degrees on the processing target image, the recognition unit 13 on the subsequent stage can recognize the object in high accuracy because the first to fourth feature amounts are invariant.

By the way, the series of the processing described above may be performed either by hardware or software. In a case where the series of processing is performed by software, a program constituting the software is installed from a program storage medium into a computer incorporated in dedicated hardware or into a multi-purpose personal computer, for example, which is capable of performing various functions when various programs are installed.

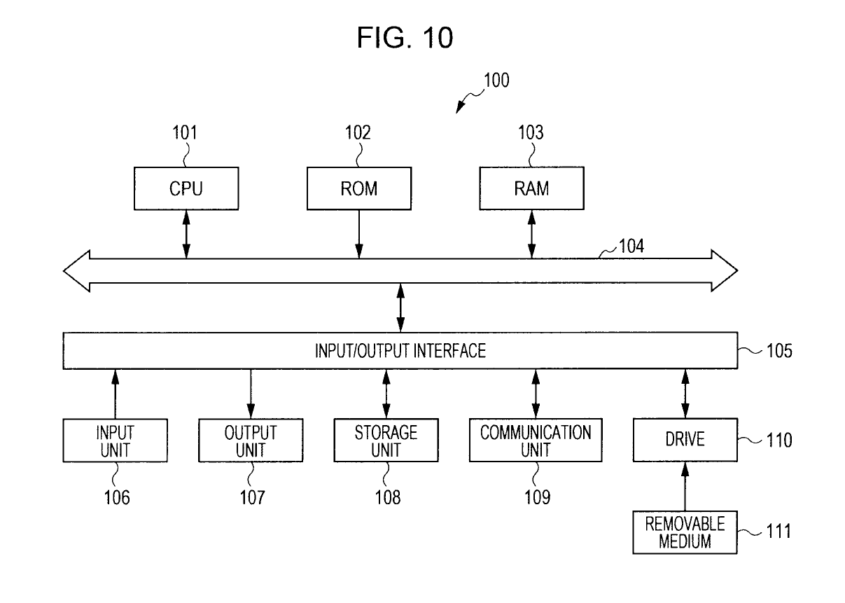

FIG. 10 is a block diagram showing a hardware configuration example of a computer which performs the series of processing described above in accordance with a program.

In this computer 100, a central processing unit (CPU) 101, a read only memory (ROM) 102, and a random access memory (RAM) 103 are connected to each other through a bus 104.

An input/output interface 105 is also connected to the bus 104. To the input/output interface 105, an input unit 106, an output unit 107, a storage unit 108, a communication unit 109, and a drive 110 are connected. The input unit 106 is a key board, a mouse, a microphone, or the like. The output unit 107 is a display, a loudspeaker, or the like. The storage unit 108 is a hard disk, a nonvolatile memory, or the like. The communication unit 109 is a network interface, for example. The drive 110 drives a removable medium 111 such as a magnetic disk, an optical disk, a magnet-optical disk, and a semiconductor memory.

In the computer 100 configured as above, the CPU 101 loads a program stored in the storage unit 108, for example, to the RAM 103 through the input/output interface 105 and the bus 104 and performs the program, thus performing the series of processing described above.

The program performed by the computer may be a program in which processing are performed in a time-series manner in accordance with the order described in this specification, or may be a program in which processing are performed in parallel or at necessary timing such as when calling is performed.

The program may be processed by a single computer or may be processed in a distributed manner by a plurality of computers. Further, the program may be transferred to a remote computer so as to be performed.

The present application contains subject matter related to that disclosed in Japanese Priority Patent Application JP 2010-022371 filed in the Japan Patent Office on Feb. 3, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing device that recognizes an object present in an image, comprising:
a filter calculation means for obtaining a plurality of filter outputs by applying a plurality of directional selectivity filters, the plurality of the directional selectivity filters respectively corresponding to different directions, to the image; and
a feature amount calculation means for calculating a plurality of feature amounts with respect to the image based on the filter outputs, the filter outputs respectively corresponding to adjacent angles, of the plurality of directional selectivity filters.

2. The image processing device according to claim 1, wherein the feature amount calculation means adds the filter outputs, the filter outputs respectively corresponding to adjacent angles, of two of the directional selectivity filters to each other so as to calculate the plurality of feature amounts with respect to the image.

3. The image processing device according to claim 1, wherein the feature amount calculation means squares the filter outputs, the filter outputs respectively corresponding to adjacent angles, of two of the directional selectivity filters and adds the squared outputs to each other so as to calculate the plurality of feature amounts with respect to the image.

4. The image processing device according to claim 1, wherein the feature amount calculation means selects a larger value of the filter outputs, the filter outputs respectively corresponding to adjacent angles, of two of the directional selectivity filters so as to calculate the plurality of feature amounts with respect to the image.

5. The image processing device according to claim 1, wherein the feature amount calculation means calculates a difference absolute value of the filter outputs, the filter outputs respectively corresponding to adjacent angles, of two of the directional selectivity filters so as to calculate the plurality of feature amounts with respect to the image.

6. The image processing device according to claim 2 to claim 5, further comprising:
a recognition means for recognizing the object present in the image based on the plurality of feature amounts, the feature amounts being calculated, with respect to the image.

7. The image processing device according to claim 2 to claim 5, wherein the directional selectivity filters are one of rectangle filters, steerable filters, and Gabor filters.

8. An image processing method of an image processing device that recognizes an object present in an image, the method comprising the steps of:
applying a plurality of directional selectivity filters, the plurality of directional selectivity filters respectively corresponding to different directions, to the image so as to obtain a plurality of filter outputs; and
calculating a plurality of feature amounts with respect to the image based on the filter outputs, the filter outputs respectively corresponding to adjacent angles, of the plurality of directional selectivity filters.

9. A program that is used for controlling an image processing device, the image processing device recognizing an object present in an image, and lets a computer of the image processing device execute a process including the steps of:
applying a plurality of directional selectivity filters, the plurality of directional selectivity filters respectively corresponding to different directions, to the image so as to obtain a plurality of filter outputs; and
calculating a plurality of feature amounts with respect to the image based on the filter outputs, the filter outputs respectively corresponding to adjacent angles, of the plurality of directional selectivity filters.

10. An image processing device that recognizes an object present in an image, comprising:
a filter calculation unit configured to obtain a plurality of filter outputs by applying a plurality of directional selectivity filters, the plurality of the directional selectivity filters respectively corresponding to different directions, to the image; and
a feature amount calculation unit configured to calculate a plurality of feature amounts with respect to the image based on the filter outputs, the filter outputs respectively corresponding to adjacent angles, of the plurality of directional selectivity filters.
